(19) United States
(12) Patent Application Publication
(10) Pub. No.: US 2005/0175265 A1
(43) Pub. Date: Aug. 11, 2005

(54) Hydrodynamic bearing system

(76) Inventors: Andreas Kull, Donaueschingen (DE); Olaf Winterhalter, Epfendorf (DE)

Correspondence Address: BAKER & DANIELS LLP;111 E. WAYNE STREET, SUITE 800, FORT WAYNE, IN, 46802, US

(21) Appl. No.: 11/042,306

(22) Filed: Jan. 25, 2005

(30) Foreign Application Priority Data
Jan. 28, 2004 (DE) 20 2004 001200.6

(51) Int. Cl. F16C 32/06

(52) U.S. Cl. 384/123

(57) ABSTRACT

The invention relates to a hydrodynamic bearing system, particularly for a spindle motor, having a shaft, a thrust plate connected to the shaft and a bearing sleeve sealed at one end by a cover plate, the bearing sleeve enclosing the shaft and the thrust plate with a slight spacing forming a bearing gap filled with a lubricant, at least one of the bearing surfaces of the shaft and the bearing sleeve as well as the thrust plate and the cover plate interacting with each other being provided with a surface structure. The distinctive feature of the invention is that a bearing surface formed between the thrust plate and the bearing sleeve is provided with a herringbone-like surface pattern and a bearing surface formed between the thrust plate and the cover plate is provided with a grooved spiral shaped surface structure.

### BACKGROUND OF THE INVENTION

The invention relates to a hydrodynamic bearing system particularly for spindle motors in hard disk drives according to the preamble in claim 1.

### OUTLINE OF THE PRIOR ART

Hydrodynamic bearings are being increasingly employed as rotary bearings in spindle motors, as used for example to drive platters in hard disk drives, alongside roller bearings which have been used for this purpose for a long time.

A hydrodynamic bearing is a further development of a sliding bearing formed from a bearing sleeve having a cylindrical inner bearing surface and a shaft having a cylindrical outer bearing surface set into the sleeve. The diameter of the shaft is slightly smaller than the inside diameter of the sleeve as a result of which a concentric bearing gap is formed between the two bearing surfaces, the bearing gap being filled with a lubricant, preferably oil, forming a continuous capillary film.

The bearing sleeve and shaft together form a radial bearing region. A surface structure taking the form of a groove pattern is formed on at least one of the two bearing surfaces, the groove pattern exerting local accelerating forces on the lubricant located in the bearing gap due to the relative rotary movement. A kind of pumping action is created in this way which presses the lubricant through the bearing gap under pressure and results in the formation of a homogeneous lubricating film of regular thickness which is stabilized by means of hydrodynamic pressure zones. The continuous, capillary lubricating film and the self-centering mechanism of the hydrodynamic radial bearing ensure that the rotation between shaft and tube is stable and concentric.

The bearing is stabilized along the rotational axis by means of an appropriately designed hydrodynamic axial bearing or thrust bearing. The thrust bearing is preferably formed by the two end faces of a thrust plate disposed at one end of the shaft, the thrust plate being accommodated in a recess formed by the bearing sleeve and a cover plate. A first end face of the thrust plate is associated with a corresponding end face of the bearing sleeve and the other end face is associated with an inner end face of the cover plate. The cover plate acts as a counter bearing to the thrust plate and seals the entire bearing system from below, preventing air from penetrating into the bearing gap filled with lubricant or from lubricant escaping from the bearing gap.

In the case of a hydrodynamic axial bearing as well, the bearing surfaces that interact with each other are provided with a surface structure in order to generate the hydrodynamic pressure required for the axial positioning of the thrust plate or the shaft in a stable manner and to ensure the circulation of the lubricant within the region of the axial bearing.

At the opposite end of the bearing, for example between the end face of the bearing sleeve and a cover, a free area can be formed that is connected to the bearing gap and acts as both a lubricant reservoir and an expansion volume for the lubricant. This area also takes on the function of sealing the bearing. Under the influence of capillary forces, the oil located in the free area forms a stable, continuous liquid film which is why this kind of seal is also referred to as a capillary seal.

A suitably designed groove pattern for the radial bearing region mentioned above can cause a pumping effect to be exerted on the lubricant in the bearing gap when the shaft is rotated. Hydrodynamic pressure is built up which is greater in the radial bearing region adjoining the axial bearing region than in the radial bearing region adjoining the free end of the shaft. If appropriate re-circulation channels are provided, a constant flow will occur in which the lubricant within the bearing gap moves towards the closed end of the bearing. It is clear that the pressure then building up in an axial direction of the bearing also prevails in the axial bearing region and results in the thrust plate not rotating in the middle of the recess that encloses it as expected, but rather that the axial bearing gap between the end faces of the thrust plate and the bearing sleeve being significantly smaller than the bearing gap between the end faces of the thrust plate and the cover plate.

The projection surfaces of the thrust plate in both axial directions are the same size so that the opposing forces acting on the thrust plate are the same in each direction and cancel each other out. This balance of forces, however, is disrupted by an additional force acting on the system which is created by the free end of the shaft also being subjected to fluid pressure in the bearing gap between the thrust plate and the cover plate. This additional force moves the shaft and the thrust plate firmly fixed to the shaft away from the cover plate in the direction of the bearing tube. The axial spacing between the end faces of the thrust plate and bearing tube then becomes smaller whereas the spacing between the end faces of the thrust plate and cover plate becomes larger. However, since the hydrodynamic pressure is all the greater, the smaller the thickness of the bearing gap, the hydrodynamic pressure in the bearing gap between the thrust plate and the bearing tube increases and the hydrodynamic pressure between the thrust plate and the cover plate decreases. The resulting force of these forces arising from the hydrodynamic pressure on both sides of the thrust plate is directed against the abovementioned force, and it is all the greater, the smaller the axial bearing gap between the thrust plate and the bearing sleeve. The thrust plate achieves a stable axial position when both resulting forces are equal and opposite.

Depending on the design and the load on the bearing, this imbalance of hydrodynamic pressure caused by the different active surfaces in the axial bearing can result in the bearing gap between the end face of the thrust plate and the bearing sleeve becoming so small that the frictional losses increasing disproportionately to the decrease in the bearing gap can cause a rise in the local temperature of the lubricant. The load carrying capacity of the axial bearing, however, is reduced due to the thermally-induced decline in its viscosity as a result of which the already narrow bearing gap is reduced even further. The end face of the thrust plate could then come dangerously close to the bearing sleeve and perhaps even touch it, which could go to shorten the useful life of the bearing or even result in damage to the bearing. To avoid local overheating of the lubricant producing the negative effects outlined above, it is known to provide connecting bores between the bearing gaps which ensure a continuous exchange of lubricant between the individual regions of the bearing gap. For this purpose, both the bearing sleeve and the thrust plate have to be provided with through holes which involves a great deal of work. If the holes are not disposed in an exactly symmetric manner this could lead to an imbalance of the rotating parts.

### SUMMARY OF THE INVENTION

It is thus the object of the invention to provide a hydrodynamic bearing system in which the above-mentioned problems concerning the axial positioning of the thrust plate can be avoided without requiring the use of through holes in the thrust plate.

This object has been achieved by a hydrodynamic bearing system having the characteristics outlined in claim 1.

Beneficial embodiments of the invention are outlined in the subordinate patent claims.

The invention provides a hydrodynamic bearing system, particularly for a spindle motor, comprising a shaft, a thrust plate firmly connected to the shaft and a bearing sleeve closed at one end by a cover plate, the bearing sleeve enclosing the shaft and the thrust plate with a slight spacing forming a concentric bearing gap filled with a lubricant, one of the bearing surfaces of the shaft, the bearing sleeve, the thrust plate or the cover plate interacting with each other being provided with a surface structure.

The distinctive feature of the invention is that a bearing surface formed between the thrust plate and the bearing sleeve is provided with a herringbone-like surface pattern and a bearing surface formed between the thrust plate and the cover plate is provided with a grooved spiral shaped surface structure.

Due to these different surface structures, differing pressures are built up on the opposite sides of the thrust plate. The herringbone pattern acting between the bearing sleeve and the top side of the thrust plate generates higher pressure than the spiral pattern acting between the cover plate and the underside of the thrust plate. Consequently, the smaller surface of the hydrodynamically active upper side of the thrust plate is subject to a greater force than the hydrodynamically active underside of the thrust plate that is larger by the end face of the shaft. The surface structures acting in the region of the thrust plate thus generate different axial forces so that an equilibrium of forces is produced when the axial spacing between the end faces of the thrust plate and the bearing tube is approximately the same size as the axial spacing between the end faces of the thrust plate and the cover plate. This goes to produce a stable axial position of the thrust plate approximately in the middle of the cavity formed by the bearing sleeve and cover plate.

As a result, the probability of damage to the bearing through physical contact between stationary and rotating parts of the axial bearing is reduced considerably. What is more, the load carrying capacity of the bearing in both axial directions is the same, although the stiffness characteristics may deviate from one another.

The invention is related in particular to hydrodynamic bearing systems in which an equalizing volume for the bearing fluid is provided in the region of one of the end faces of the bearing, the equalizing volume preferably being designed as a cavity having an approximately conical cross-section connected either directly or indirectly to the bearing gap.

Within the scope of the invention, provision can further be made for a lubricant-carrying connection between the equalizing volume and regions of the bearing gap to be formed by means of a connecting channel. The connecting channel can preferably extend within the bearing sleeve.

Further characteristics, advantages and possible applications of the invention can be derived from the following description of the drawings.

### BRIEF DESCRIPTION OF THE DRAWINGS

The invention is described in more detail below on the basis of preferred embodiments with reference to the drawings. The figures show:

FIG. 1 a schematic longitudinal view of a spindle motor having the hydrodynamic bearing system according to the invention;

FIG. 2 a view from above of the cover plate of the thrust bearing;

FIG. 3 a view from below of the bearing sleeve.

### DESCRIPTION OF A PREFERRED EMBODIMENT OF THE INVENTION

The drawings show a spindle motor having a hydrodynamic bearing system to drive the platters of a hard disk drive. In the illustrated embodiment, the shaft is rotatably supported in a stationary bearing sleeve. It is of course clear that the invention also includes designs in which a stationary shaft is enclosed by a rotating bearing sleeve.

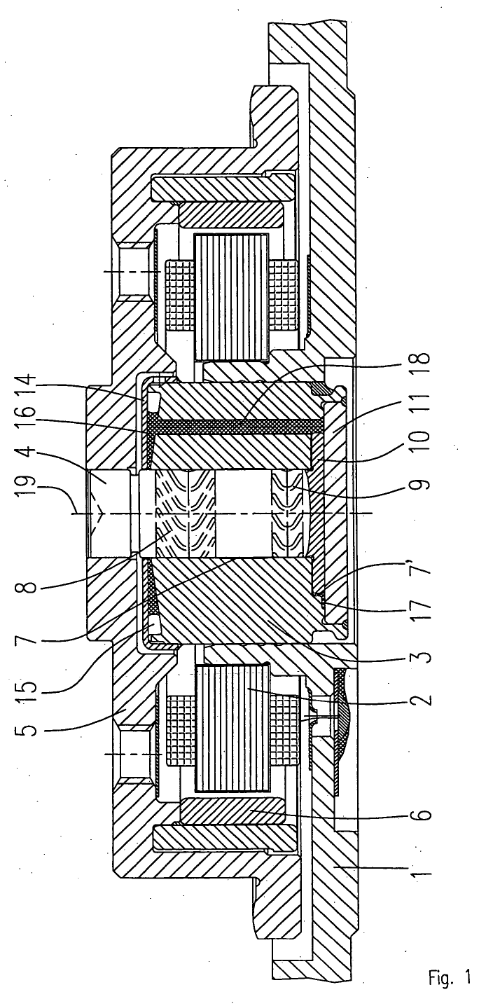

The spindle motor according to FIG. 1 comprises a stationary baseplate 1 on which a stator arrangement 2, consisting of a stator core and windings, is arranged.

A bearing sleeve 3 is fixedly accommodated in a recess in the baseplate 1 and has a cylindrical axial bore in which a shaft 4 is rotatably accommodated. One end of the shaft 4 (the lower) is connected to a thrust plate 10, whereas the other free end of the shaft carries a rotor 5 on which one or more platters (not illustrated) of the hard disk drive are disposed and fixed. An annular permanent magnet 6 having a plurality of pole pairs is arranged on the lower inside edge of the rotor 5, an alternating electrical field being applied to the pole pairs by a stator arrangement 2 spaced apart from them by means of an air gap, so that the rotor 5, together with the shaft 4, is put into rotation.

Radial bearing regions having a bearing gap 7 are provided between the inside diameter of the bearing sleeve 3 and the slightly smaller outside diameter of the shaft 4, the bearing gap 7 being filled with a lubricant, preferably a liquid bearing fluid. These radial bearing regions are marked by a surface structure taking the form of groove patterns 8, 9 which, in the illustrated embodiment, are provided on the surface of the bearing sleeve 3. As soon as the shaft 4 is set in rotation, hydrodynamic pressure is built up in the bearing gap 7 or in the lubricant found in the bearing gap due to the groove patterns 8, 9, so that the bearing can then support a load.

Together with a cover plate 11, the thrust plate 10 forms a hydrodynamic thrust bearing. The thrust bearing provides for the axial positioning of the shaft 4 with respect to the bearing sleeve 3 of the bearing arrangement and takes up the axial load. This axial bearing region is hermetically sealed by the cover plate 11 so that no lubricant can escape from the bearing gap 7 which continues as a bearing gap 7′ between the bearing sleeve 3, thrust plate 10 and cover plate 11.

To ensure that sufficient hydrodynamic pressure is built up in the axial bearing, the surfaces of the bearing sleeve 3, the thrust plate 10 or the cover plate 11 facing each other are likewise provided with a groove pattern 12, 13.

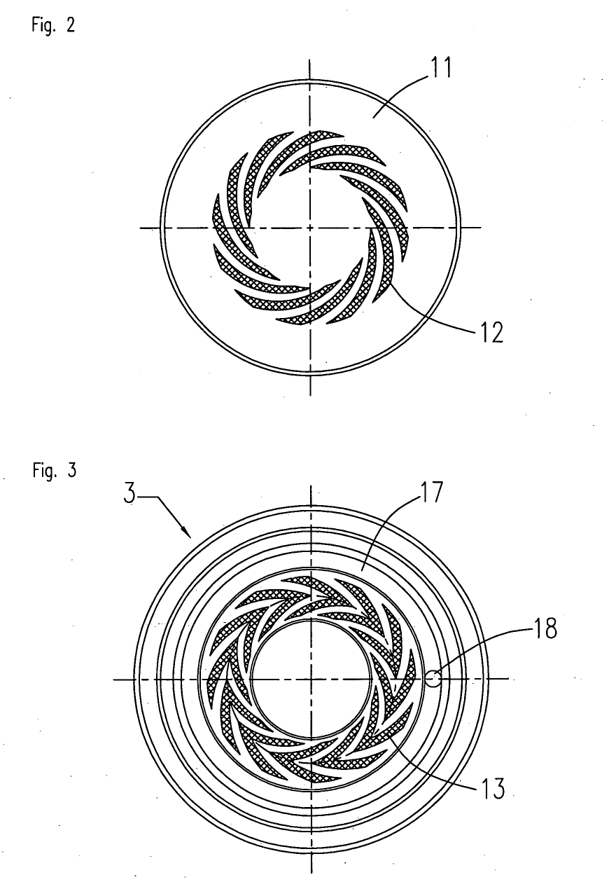

These surface structures are shown in more detail in FIGS. 2 and 3. According to the invention, the surface of the bearing sleeve 3 facing the thrust plate 10 has a herringbone-like surface structure 13, whereas the surface of the cover plate 11 facing the thrust plate 10 has a grooved spiral shaped surface structure 12. These different surface structures produce such a force distribution acting on the thrust plate 10 that the axial spacing between the thrust plate 10 and the bearing sleeve 3 on the one hand and between the thrust plate 10 and the cover plate 11 on the other hand are approximately the same size.

It goes without saying that the invention also includes the event that either one or both of the above surface structures 12, 13 can be provided on the thrust plate 10.

The bearing sleeve 3 is sealed at the free end of the shaft 4 by a preferably can-shaped covering cap 14 that is set on the bearing sleeve 3. The covered end face of the bearing sleeve 3 is provided with a chamfer or a counterbore that extends from the region of the bearing sleeve 3 located close to the shaft radially outwards as far as the outer circumference of the bearing sleeve 3. This goes to form a tapered area having a conical cross-section widening towards the outside between the end face of the bearing sleeve 3 and the inside of the covering cap 14 acting as an equalizing volume 15 for the bearing fluid and bearing at least partly filled with lubricant 16. The region of the equalizing volume 15 located radially towards the inside adjoins the bearing gap 7.

A connecting channel 18 preferably running within the bearing sleeve 3 connects the equalizing volume 15 to the lower region 7′ of the bearing gap. This channel 18 allows lubricant 16 to be exchanged between the equalizing volume 15 and the lower region 7′ of the bearing gap, so that a constant circulation of lubricant 16 in the region of the radial bearing is also ensured.

The characteristics revealed in the above description, the claims and the drawings can be important for the realization of the invention in its various embodiments both individually and in any combination whatsoever.

Identification Reference List
1 Baseplate
2 Stator arrangement 3 Bearing sleeve 4 Shaft
5 Rotor
6 Permanent magnet
7 Bearing gap 7′
8 Surface structure
9 Surface structure
10 Thrust plate
11 Cover plate
12 Surface structure
13 Surface structure
14 Covering cap
15 Equalizing volume
16 Lubricant
17 Annular groove
18 Connecting channel
19 Rotational axis

1. A hydrodynamic bearing system, particularly for a spindle motor, having a shaft, a thrust plate connected to the shaft and a bearing sleeve sealed at one end by a cover plate, the bearing sleeve enclosing the shaft and the thrust plate with a slight spacing forming a bearing gap filled with a lubricant, at least one of the bearing surfaces of the shaft and the bearing sleeve as well as the thrust plate and cover plate interacting with each other being provided with a surface structure,
characterized in that,
one of the two bearing surfaces formed between the thrust plate and the bearing sleeve is provided with a herringbone-like surface structure and one of the two bearing surfaces formed between the thrust plate and the cover plate is provided with a grooved spiral shaped surface structure.

2. A hydrodynamic bearing system according to claim 1, characterized in that an equalizing volume for the lubricant is provided in the region of at least one end face of the bearing system.

3. A hydrodynamic bearing system according to claim 1, characterized in that the equalizing volume is formed as an approximately cone-shaped cavity connected directly or indirectly to the bearing gap.

4. A hydrodynamic bearing system according to claim 1, characterized in that the equalizing volume is connected to the bearing gap by at least one connecting channel.

5. A hydrodynamic bearing system according to claim 1, characterized in that the connecting channel extends at an angle of between 0° and 90°, preferably approximately parallel, to the rotational axis of the bearing system.

6. A hydrodynamic bearing system according to claim 2, characterized in that the equalizing volume is formed as an approximately cone-shaped cavity connected directly or indirectly to the bearing gap.

7. A hydrodynamic bearing system according to claim 2, characterized in that the equalizing volume is connected to the bearing gap by at least one connecting channel.

8. A hydrodynamic bearing system according to claim 3, characterized in that the equalizing volume is connected to the bearing gap by at least one connecting channel.

9. A hydrodynamic bearing system according to claim 2, characterized in that the connecting channel extends at an angle of between 0° and 90°, preferably approximately parallel, to the rotational axis of the bearing system.

10. A hydrodynamic bearing system according to claim 3, characterized in that the connecting channel extends at an angle of between 0° and 90°, preferably approximately parallel, to the rotational axis of the bearing system.

11. A hydrodynamic bearing system according to claim 4, characterized in that the connecting channel extends at an angle of between 0° and 90°, preferably approximately parallel, to the rotational axis of the bearing system.
